(19) United States
(12) Patent Application Publication
(10) Pub. No.: US 2024/0153025 A1
(43) Pub. Date: May 9, 2024

(54) STUDENT MIGRATION VISUALIZATION TOOL

(71) Applicant: METROPOLITAN STATE UNIVERSITY OF DENVER, Denver, CO (US)

(72) Inventors: Kelsey SMITH, Denver, CO (US); Sean PETRANOVICH, Denver, CO (US)

(21) Appl. No.: 18/053,175

(22) Filed: Nov. 7, 2022

(51) Int. Cl. G06Q 50/20; G06Q 30/0204

(52) U.S. Cl. CPC G06Q 50/205; G06Q 30/0204

(57) ABSTRACT

A method for generating a visualization of movement of a cohort of students through an educational institution includes obtaining status data for the cohort of students over a time period and determining standing statuses for students of the cohort of students, where the standing statuses are determined at a plurality of discrete time points over the time period. The method further includes generating the visualization of the standing statuses over the time period, where the visualization shows changes between the standing statuses over the time period. The method further includes displaying, via a user interface at a user device, the visualization responsive to a user request received from the user device to view the visualization.

### BACKGROUND

Student retention and progress towards completion of a degree program are often high priorities for educational institutions. Tracking the movement of students through an institution and identifying end points (e.g., degree, job within a relevant career field, etc.) is difficult due to the variety of data collected and the need to synthesize data, as well as lack of data for certain types of end points. This is especially true for institutions with large numbers of non-traditional students, such as part-time, first generation, and transfer students, where students may take time off, may change institutions, or may otherwise have a non-traditional experience through their education path. Even where the data is collected and synthesized, it is difficult to visualize and identify patterns in student behavior and standing over time. Such patterns are helpful in improving and targeting retention efforts for educational institutions.

### SUMMARY

An example method for generating a visualization of movement of a cohort of students through an educational institution is disclosed. The method includes obtaining status data for the cohort of students over a time period and determining standing statuses for students of the cohort of students, where the standing statuses are determined at a plurality of discrete time points over the time period. The method further includes generating the visualization of the standing statuses over the time period, where the visualization shows changes between the standing statuses over the time period. The method further includes displaying, via a user interface at a user device, the visualization responsive to a user request received from the user device to view the visualization.

In some examples, the status data may include a number of credit hours earned at the educational institution by students of the cohort of students at each of the plurality of discrete time points over the time period.

In some examples, the status data may include enrollment status of at least one student of the cohort of students at a second educational institution during the time period, where the second educational institution is different than the educational institution.

In some examples, obtaining the status data for the cohort of students over the time period may include obtaining the number of credit hours earned at the educational institution by students of the cohort of students from a first datastore and obtaining the enrollment status of the at least one student of the cohort of students at the second educational institution from a second datastore.

In some examples, determining standing statuses for the cohort of students over the time period may include using the number of credit hours earned at the educational institution by each student of the cohort of students at each of the plurality of discrete time points over the time period.

In some examples, the method may further include: receiving, via the user interface at the user device, a second user request to generate a second visualization for a subset of the cohort of students over the time period, where the subset of students includes students having a demographic characteristic; obtaining demographic data for the cohort of students; identifying the subset of the cohort of students based on the demographic data; and generating the second visualization of standing statuses of the subset of the cohort of students over the time period.

In some examples, the visualization may show at least the standing statuses of the cohort of students at each of the plurality of discrete time points over the time period.

In some examples, the visualization may include a plurality of visual elements represent the cohort of students, where the visualization shows the visual elements in motion.

An example computing system disclosed herein includes one or more processors and memory containing instructions which, when executed by the one or more processors, cause the computing system to perform a method. The method includes receiving, via a user interface at a user device in communication with the computing system, a request to generate a visualization of standing statuses of a cohort of students over a time period and obtaining, from at least two databases, status data for the cohort of students over the time period. The method further includes determining standing statuses for students of the cohort of students, where the standing status is determined at a plurality of discrete time points over the time period and generating the visualization of the standing statuses of the cohort of students over the time period, where the visualization shows changes between the standing statuses over the time period. The method further includes displaying, via the user interface, the visualization.

In some examples, obtaining, from at least two databases, status data for the cohort of students may include obtaining a number of credit hours earned at the educational institution by each student of the cohort of students from a first datastore, where the first datastore is associated with the educational institution and obtaining an enrollment status of at least one student of the cohort of students at a second educational institution from a second datastore, where the second datastore is associated with an entity separate from the educational institution.

In some examples, the status data may include a number of credit hours earned at the educational institution by students of the cohort of students at each of the plurality of discrete time points over the time period.

In some examples, determining standing statuses for the cohort of students over the time period may include using the number of credit hours earned at the educational institution by students of the cohort of students at each of the plurality of discrete time points over the time period.

In some examples, the visualization may show at least the standing statuses of the cohort of students at each of the plurality of discrete time points over the time period.

In some examples, the visualization may include a plurality of visual elements representing the cohort of students, where the visualization shows the visual elements in motion.

In some examples, the method may further include: receiving, via the user interface, a request to update a display characteristic of the visualization; generating an updated visualization based on the request; and displaying, via the user interface, the updated visualization.

An example method for generating a visualization of movement of a cohort of students through an educational institution is disclosed. The method includes obtaining status data for the cohort of students over a time period, where the status data includes a number of credit hours earned by students of the cohort at the educational institution at a plurality of discrete time points over the time period. The method further includes determining, based on the number of credit hours earned by each student of the cohort of students, standing statuses for students of the cohort of students at each of the plurality of discrete time points over the time period. The method further includes generating the visualization of movement of the cohort of students over the time period, where the visualization shows at least the standing statuses of the cohort of students at each of the plurality of discrete time points and displaying, via a user interface, the visualization responsive to a user request received from the user device to view the visualization.

In some examples, the status data may further include an enrollment status of at least one student of the cohort of students at a second educational institution, where obtaining status data for the cohort of students over the time period includes: obtaining the number of credit hours earned by students of the cohort of students at the educational institution at a plurality of discrete time points from a first datastore; and obtaining the enrollment status of the at least one student of the cohort of students at a second educational institution from a second datastore.

In some examples, the visualization may include a plurality of visual elements representing the cohort of students, where the visualization shows the visual elements in motion.

In some examples, the plurality of visual elements are colored and clustered together based on the standing statuses of the cohort of students.

In some examples, the method may further include: receiving, via the user interface at the user device, a second user request to generate a second visualization for a subset of the cohort of students over the time period, where the subset of students have a demographic characteristic; obtaining demographic data for the cohort of students; identifying the subset of the cohort of students based on the demographic data; and generating the second visualization of standing statuses of the subset of the cohort of students over the time period.

Additional embodiments and features are set forth in part in the description that follows, and will become apparent to those skilled in the art upon examination of the specification and may be learned by the practice of the disclosed subject matter. A further understanding of the nature and advantages of the present disclosure may be realized by reference to the remaining portions of the specification and the drawings, which form a part of this disclosure. One of skill in the art will understand that each of the various aspects and features of the disclosure may advantageously be used separately in some instances, or in combination with other aspects and features of the disclosure in other instances.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The description will be more fully understood with reference to the following figures in which components are not drawn to scale, which are presented as various examples of the present disclosure and should not be construed as a complete recitation of the scope of the disclosure, characterized in that:

FIG. 1 illustrates an example system including a student migration system, in accordance with various embodiments of the disclosure.

FIG. 2 is a schematic diagram of an example computer system implementing various embodiments in the examples described herein.

FIG. 3A illustrates example user interfaces showing visualizations of standing statuses of a cohort of students at various discrete time points over a period of time, in accordance with various embodiments of the disclosure.

FIG. 3B illustrates example user interfaces showing visualizations of standing statuses of a cohort of students at various discrete time points over a period of time, in accordance with various embodiments of the disclosure.

FIG. 3C illustrates example user interfaces showing visualizations of standing statuses of a cohort of students at various discrete time points over a period of time, in accordance with various embodiments of the disclosure.

FIG. 3D illustrates example user interfaces showing visualizations of standing statuses of a cohort of students at various discrete time points over a period of time, in accordance with various embodiments of the disclosure.

FIG. 3E illustrates example user interfaces showing visualizations of standing statuses of a cohort of students at various discrete time points over a period of time, in accordance with various embodiments of the disclosure.

FIG. 3F illustrates example user interfaces showing visualizations of standing statuses of a cohort of students at various discrete time points over a period of time, in accordance with various embodiments of the disclosure.

FIG. 3G illustrates example user interfaces showing visualizations of standing statuses of a cohort of students at various discrete time points over a period of time, in accordance with various embodiments of the disclosure.

FIG. 3H illustrates example user interfaces showing visualizations of standing statuses of a cohort of students at various discrete time points over a period of time, in accordance with various embodiments of the disclosure.

FIG. 3I illustrates example user interfaces showing visualizations of standing statuses of a cohort of students at various discrete time points over a period of time, in accordance with various embodiments of the disclosure.

FIG. 3J illustrates example user interfaces showing visualizations of standing statuses of a cohort of students at various discrete time points over a period of time, in accordance with various embodiments of the disclosure.

FIG. 3K illustrates example user interfaces showing visualizations of standing statuses of a cohort of students at various discrete time points over a period of time, in accordance with various embodiments of the disclosure.

FIG. 3L illustrates example user interfaces showing visualizations of standing statuses of a cohort of students at various discrete time points over a period of time, in accordance with various embodiments of the disclosure.

FIG. 3M illustrates example user interfaces showing visualizations of standing statuses of a cohort of students at various discrete time points over a period of time, in accordance with various embodiments of the disclosure.

FIG. 3N illustrates example user interfaces showing visualizations of standing statuses of a cohort of students at various discrete time points over a period of time, in accordance with various embodiments of the disclosure.

FIG. 3O illustrates example user interfaces showing visualizations of standing statuses of a cohort of students at various discrete time points over a period of time, in accordance with various embodiments of the disclosure.

FIG. 4 illustrates example user interfaces showing visualizations of standing statuses of a cohort of students over a period of time, in accordance with various embodiments of the disclosure.

FIG. 5 illustrates an example user interface showing a visualization of standing statuses of a cohort of students over a period of time, in accordance with various embodiments of the disclosure.

FIG. 6 is a flow diagram of operations for generating and displaying a visualization of standing statuses of a cohort of students over a period of time, in accordance with various embodiments of the disclosure.

FIG. 7 is a flow diagram of operations for determining standing statuses for a cohort of students over a period of time, in accordance with various embodiments of the disclosure.

### DETAILED DESCRIPTION

The student migration system described herein allows for the collection of cohort data and status data for a group of students and provides meaningful visualizations of the collected data for the students. Such visualizations may assist in identifying patterns of student behavior over time, allowing educational institutions to improve and target retention efforts. Traditionally, even with some relevant data, meaningful analysis of the data may be impossible, especially in instances where the data may be incomplete or unclear. The student migration system may generally obtain status data (either from its own database and/or from multiple other institutions or third parties) for a group or cohort of students. For example, all students starting at the institution at the same time may be part of a cohort. Status data may include the total number of credit hours the students in the cohort have earned towards graduation. Status data may generally be point-in-time data, reflecting the status of an individual at a specific time. The student migration system may then synthesize or analyze the status data into standing statuses for the students in the cohort. For example, students may be categorized as freshman, sophomores, juniors, or seniors (or other standings relevant for progression towards a degree). Other standing statuses may be used for students who have transferred to another institution, graduated from the institution, taken a hiatus, or dropped out of a program or the institution.

The student migration system may utilize the standing statuses for the cohort to analyze the data and generate and display visualizations of the standing statuses of the cohort of students over a time period. For example, visualizations may include graphical elements correlating to each student and show the graphical elements moving between the different available standing statuses over the time period. Other visualizations may show graphs, charts, or other visual elements showing how the cohort of students (or sub-groups of the cohort of students) move between the various standing statuses.

Often, institutional personnel collaborate on improving retention efforts and personnel leading retention efforts may not be accustomed to interacting with unformatted and/or unanalyzed data, such as data presented merely in a spreadsheet. Accordingly, it may be difficult for personnel involved in collecting data to identify and/or convey patterns, trends, or other important elements of the data to the personnel leading retention efforts. The visualizations generated by the student migration system may assist in identifying and communicating patterns among cohorts of students, such as identifying terms where a large number of students in a cohort dropped out, the length of typical hiatuses, average time to graduation, and the like. Such patterns may help in improving retention efforts, ultimately resulting in more students completing degree programs. For example, where a large number of students drop out after the first year of study, the educational institution may provide additional academic support, counseling, or other resources to students within the first year.

In some examples, the visualizations generated by the student migration system may be configurable to view standing statuses over time for particular sub-groups of students within a cohort. For example, student identifiers may be associated with various demographic information such as race, sex, first generation student status, major, financial aid status, secondary school of origin, and the like. Accordingly, the student migration system may be used to view the paths of a subset or sub-group of students such that retention efforts may be tailored to that group of students. For example, a visualization showing the paths of first generation students may show a large number of first generation students dropping out after the first semester or term of attendance. Such insights may assist an educational institution in identifying such patterns and, for example, adding additional supports or resources geared towards first generation students during their first term of attendance at the educational institution. The systems and methods described herein may be used to visualize student movement at a variety of educational institutions including, for example, colleges or universities, community colleges, trade schools, charter schools, professional or graduate programs, and the like.

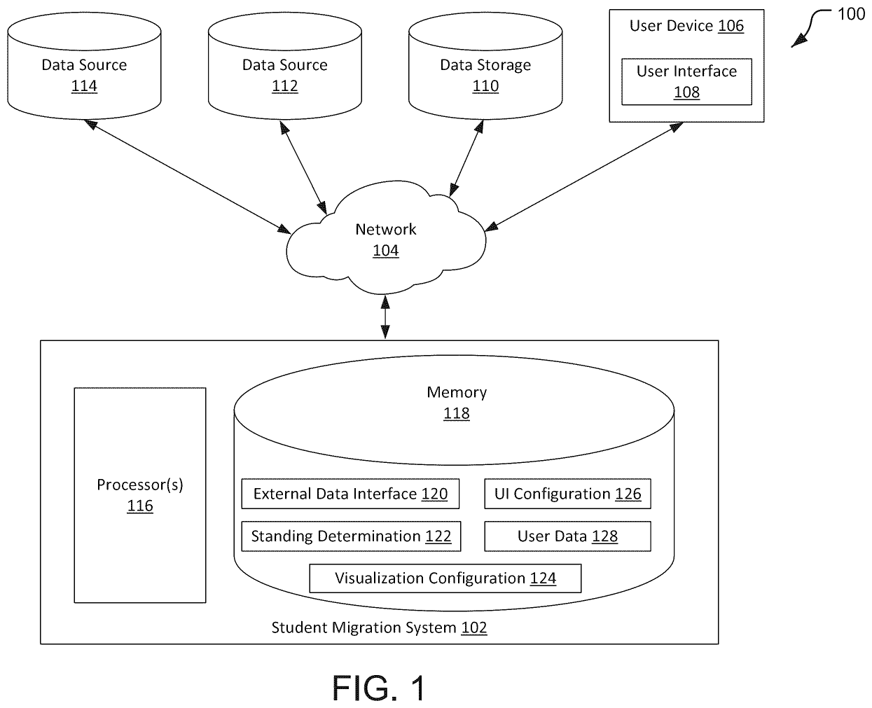

Turning now to the drawings, FIG. 1 illustrates an example system 100 including a student migration system 102 and various systems in communication with the student migration system 102 through a network 104, in accordance with various embodiments of the disclosure. Generally, the student migration system 102 may communicate with the user device 106, data storage 110, data sources 112 and 114, and various other components through the network 104 to configure, generate, and/or display one or more visualizations of standing statuses of a cohort of students over a period of time. For example, the student migration system 102 may obtain status data for the students of the cohort of students from data sources 112 and/or 114, configure the visualization, and communicate the visualization to the user device 106 and/or data storage 110. For example, the student migration system 102 may transmit the visualization to the user device 106 for viewing via the user interface 108 of the user device 106. Alternatively or additionally, the student migration system 102 may transmit the visualization to data storage 110 and/or other data storage locations to store the visualization for later access.

Data sources 112 and 114 may be implemented by one or more computing devices or combinations of computing resources in various embodiments. Data sources 112 and 114 may generally be accessible by the student migration system 102 via the network 104. Data sources 112 may, in various examples, be databases or datastores maintained by the educational institution including various data, such as student demographic information, enrollment information, and the like. For example, data sources 112 and 114 may include databases maintained by different offices or departments of the educational institution, such as a registrar's office, scholarship office, finance office, and the like. Data sources 112 and 114 may also include third party data sources (e.g., the National Student Clearinghouse® database, data stores associated with other educational institutions, and the like). Storage 110 may store various data utilized and/or created by the student migration system 102. For example, storage 110 may store data used to display visualizations generated by the student migration system 102, user settings, and the like.

The network 104 may be implemented using one or more of various systems and protocols for communications between computing devices. In various embodiments, the network 104 or various portions of the network 104 may be implemented using the Internet, a local area network (LAN), a wide area network (WAN), and/or other networks. In addition to traditional data networking protocols, in some embodiments, data may be communicated according to protocols and/or standards including near field communication (NFC), Bluetooth, cellular connections, and the like.

In various implementations, the user device 106 and/or additional user devices may be implemented using any number of computing devices including, but not limited to, a computer, a laptop, table, mobile phone, smart phone, wearable device (e.g., AR/VR headset, smart watch, smart glasses, or the like), smart speaker, vehicle (e.g., automobile), or appliance. Generally, the user device 106 and/or other user devices may include one or more processors, such as a central processing unit (CPU) and/or graphics processing unit (GPU). The user device 106 may generally perform operations by executing executable instructions (e.g., software) using the processor(s). For example, the user device may communicate requests to the student migration system 102 to generate visualizations of student data, view various visualization created by the student migration system 102 via a user interface 108 of the user device 106, and the like.

In various examples, the user interface 108 at the user device 106 may be used to provide information to (e.g., requests for new visualizations, settings for visualization creation, user credentials, and the like) and display information from (e.g., visualization generated by the student migration system 102) the student migration system 102. The user interface 108 may also access various components of the student migration system 102 through webpages, one or more applications at the user device 106, or using other methods. In various examples, the user interface 108 may be a display of a computing device, such as a smart phone, personal computer, laptop computer, tablet, AR/VR device, and the like.

In various examples, the student migration system 102 may include or utilize one or more hosts or combinations of compute resources, which may be located, for example, at one or more servers, cloud computing platforms, computing clusters, and the like. Generally, the student migration system 102 is implemented by compute resources including hardware for memory 118 and one or more processors 116. For example, the student migration system 102 may utilize or include one or more processors, such as a CPU, GPU, and/or programmable or configurable logic. In some embodiments, various components of the student migration system 102 may be distributed across various computing resources, such that the components of the student migration system 102 communicate with one another through the network 104 or using other communications protocols. For example, in some embodiments, the student migration system 102 may be implemented as a serverless service, where computing resources for various components of the student migration system 102 may be located across various computing environments (e.g., cloud platforms) and may be reallocated dynamically and/or automatically according to, for example, resource usage of the student migration system 102. In various implementations, the student migration system 102 may be implemented using organizational processing constructs such as functions implemented by worker elements allocated with compute resources, containers, virtual machines, and the like.

The memory 118 may include instructions for various functions of the student migration system 102 which, when executed by processor 116, perform various functions of the student migration system 102. The memory 118 may further store data and/or instructions for retrieving data used by the student migration system 102. Similar to the processor 116, memory resources utilized by the student migration system 102 may be distributed across various physical computing devices. In some examples, memory 118 may access instructions and/or data from other devices or locations, and such instructions and/or data may be read into memory 118 to implement the student migration system 102.

The memory 118 may store user data 128 which may, in various examples, be used by the student migration system 102 to generate user interfaces, determine student standing, retrieve cohort data, authenticate users and/or user devices, and the like. For example, user data 128 may include access information for sources of status data (e.g., universal resource locators (URLs), access information, query information, and the like for various data sources). User data 128 may further include information used to generate visualizations, including information used to obtain standing statuses from status data. For example, user data 128 may include correlations between number of credit hours earned and student standing at the institution, requirements for graduation for various degree programs, and the like. User data 128 may further include information or settings used by the student migration system 102 to generate various visualizations of student standings. For example, settings may include visualization speed, discrete time points for calculation of standing status, and the like.

The memory 118 may include instructions implementing an external data interface 120. The external data interface 120 may generally obtain status data for a cohort of students during a time period. In various examples, such status data may be obtained from two or more separate datastores. The external data interface 120 may connect with external data sources (e.g., a clearinghouse database) to obtain various information, such as status data for students at an educational institution. For example, status data may include a number of credit hours earned by a student applicable to a degree program at the educational institution, courses completed at or transferred to the educational institution, total number of credit hours earned by a student in post-secondary education, and the like. Status data may further include, in various examples, what major or majors a student is enrolled in, clubs, sports teams, or support programs a student is enrolled in, and the like. The external data interface 120 may, in some examples access user data 128 to access information about where and how to access such status data. For example, the user data 128 may include URLs for databases including status data, access information such as login credentials, and/or additional information for accessing status data, such as structured queries for databases accessible using the external data interface 120.

In various examples, the external data interface 120 may access several databases or data sources to obtain full status data for a cohort of students at an educational institution. For example, the external data interface 120 may first access a data source associated with the educational institution to identify students in the cohort and obtain status data (e.g., numbers of credit hours earned) as recorded at the data source associated with the educational institution. In some examples, each student in the cohort may be associated with a student identifier, which is common across various institutions of higher education and may be used, for example, to identify the same student in a larger clearinghouse of student data. In these examples, the external data interface 120 may identify students in the cohort, including student identifiers associated with each student in the cohort. External data interface 120 may then obtain status data (e.g., a number of credit hours earned, courses completed, and the like) from both the data source associated with the educational institution and from, for example, a national clearinghouse database. Accordingly, the external data interface 120 may obtain information about credit hours completed by a student at other institutions, such as credit hours earned after a student has transferred out of the original educational institution. Such information may be useful for determining, for example, when a student has transferred out of the original educational institution.

In various examples, the external data interface 120 may pull other student data in addition to status data. Such additional student data may include, for example, demographic data. Such demographic data may be used by the student migration system 102 to, for example, generate visualizations for sub-groups of the cohort of students. For example, demographic data may include major data, financial aid status, race, sex, protected status, high school of origin, first generation student status, and other groupings of students. Visualizations of such sub-groupings of students or including information about sub-groupings of students may further assist in targeting retention efforts by showing how various sub-groupings of students progress towards degrees, including, in some examples, as compared to the general cohort of students.

The memory 118 further includes instructions implementing standing determination 122. Standing determination 122 may generally utilize status data retrieved using the external data interface 120 to calculate standing statuses at discrete time intervals over a relevant period of time for the visualization. Standing statuses may be, for example, class status overall (e.g., freshman, sophomore, junior, senior, or equivalents), class status within a particular major, transfer status, hiatus status, drop-out status, and the like. Status data may include, for example, number of credit hours earned at the educational institution, transferred into the educational institution for credit, the number of credit hours earned at other educational institutions, and the like.

In various examples, standing determination 122 may evaluate the total credit hours earned by each student at predefined intervals during the time period (e.g., at the end of each semester or other term system used by the educational institution) and translate the number of credit hours to a class standing status using standing definitions provided by the educational institution. For example, standing determination 122 may compare the number of credit hours earned by a student to ranges of credit hours provided by the educational institution corresponding to different class or year standings. Standing determination 122 may further utilize definitions provided by the educational institution to determine when a student has graduated, has transferred, has dropped out, or has taken a hiatus. The standing status generated by standing determination 122 may be utilized by visualization configuration 124 to generate visualizations of the standing statuses for the cohort of students.

The memory 118 further includes instructions implementing visualization configuration 124. Visualization configuration 124 may generally generate visualizations of the standing statuses of the cohort of students over a given period of time. Such visualizations may include various charts, graphs, images, moving images and the like. For example, visualization configuration 124 may receive user requests for various types of visualizations and may generate the visualizations based on standing statuses (e.g., the standing statuses generated by standing determination 122).

In some examples, a visualization generated by visualization configuration 124 may graphically or visually show the movement of students (e.g., the paths of students) through an educational institution. An example visualization generated by visualization configuration 124 may include visual elements (e.g., colored dots, icons, or the like) representing individual students (e.g., one element per student) or a collection of students (e.g., five students) and different areas of the visualization may indicate different standing statuses. The visual elements representing the students may then move or transition between the different areas and standing statuses of the students change over a time period. Such visualizations may show, for example, a large number of visual elements moving from a freshman standing to a dropped out standing after a first semester, indicating that a large number of students dropped out after their first semester at the educational institution. Such visualizations may be dynamic, updating as the visualization moves between different points in time in the time period. Other types of visualizations, such as bar or line graphs, illustrations, and the like, may also be generated by visualization configuration 124.

The memory 118 further includes instructions implementing UI configuration 126. UI configuration 126 may generally configure user interfaces for viewing by a user (e.g., through the user interface 108 of the user device 106). Such user interfaces may include visualizations generated by visualization configuration 124 and/or user interfaces configured to receive requests for visualizations, settings, and/or other types of input from a user. UI configuration 126 may further receive information from, and communicate information to, other components of the student migration system 102. For example, UI configuration 126 may receive, via the user interface 108 a request for a new visualization, including settings for the visualization (e.g., selection of the cohort of students, time period, and the like). UI configuration 126 may relay the request to the external data interface 120 to retrieve relevant data, to standing determination 122 to generate standing statuses for the visualization, and/or to visualization configuration 124. UI configuration 126 may receive a completed visualization from visualization configuration 124 and may communicate the completed visualization to user interface 108 of the user device 106.

In some examples, the memory 118 may include additional instructions implementing additional features of the student migration system 102 not described above. For example, the memory 118 may include instructions implementing authentication procedures for accessing the student migration system 102.

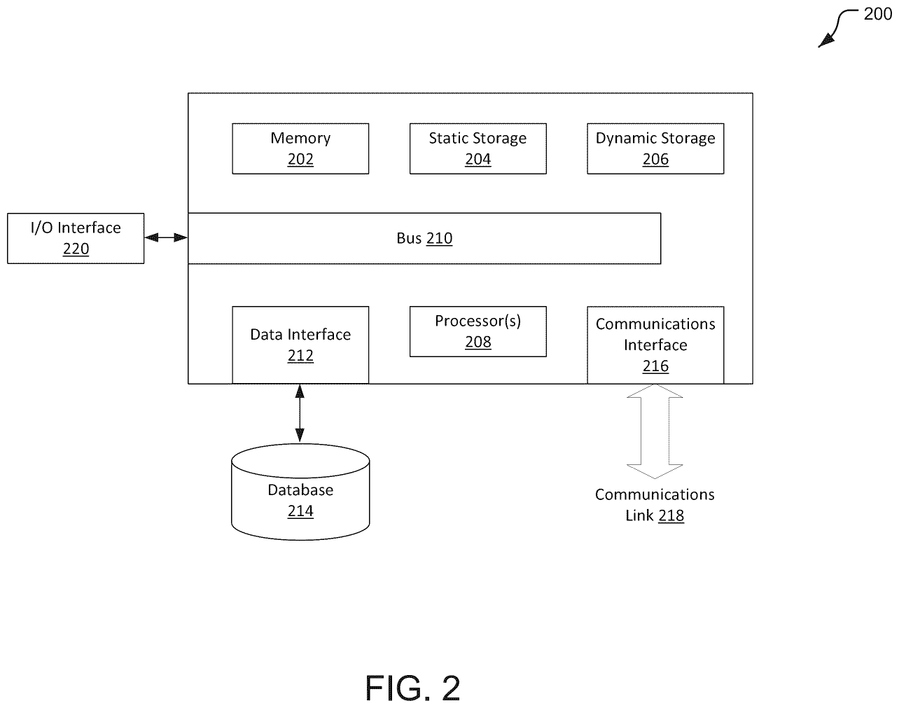

The student migration system 102 may be implemented using various computing systems. Turning to FIG. 2, an example computing system 200 may be used for implementing various embodiments in the examples described herein. For example, processor 116 and memory 118 may be located at one or several computing systems 200. In various embodiments, user device 106 is also implemented by a computing system 200. This disclosure contemplates any suitable number of computing systems 200. For example, the computing system 200 may be a server, a desktop computing system, a mainframe, a mesh of computing systems, a laptop or notebook computing system, a tablet computing system, an embedded computing system, a system-on-chip, a single-board computing system, or a combination of two or more of these. Where appropriate, the computing system 200 may include one or more computing systems; be unitary or distributed; span multiple locations; span multiple locations; span multiple machines; span multiple data centers; or reside in a cloud, which may include one or more cloud components in one or more networks.

Computing system 200 includes a bus 210 (e.g., an address bus and a data bus) or other communication mechanism for communicating information, which interconnects subsystems and devices, such as processor 208, memory 202 (e.g., RAM), static storage 204 (e.g., ROM), dynamic storage 206 (e.g., magnetic or optical), communications interface 216 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), input/output (I/O) interface 220 (e.g., keyboard, keypad, mouse, microphone). In particular embodiments, the computing system 200 may include one or more of any such components.

In particular embodiments, processor 208 includes hardware for executing instructions, such as those making up a computer program. The processor 208 circuitry includes circuitry for performing various processing functions, such as executing specific software for perform specific calculations or tasks. In particular embodiments, I/O interface 220 includes hardware, software, or both, providing one or more interfaces for communication between computing system 200 and one or more I/O devices. Computing system 200 may include one or more of these I/O devices, where appropriate. One or more of these I/O devices may enable communication between a person and computing system 200.

In particular embodiments, communications interface 216 includes hardware, software, or both providing one or more interfaces for communication (such as, for example, packet-based communication) between computing system 200 and one or more other computer systems or one or more networks. One or more memory buses (which may each include an address bus and a data bus) may couple processor 208 to memory 202. Bus 210 may include one or more memory buses, as described below. In particular embodiments, one or more memory management units (MMUs) reside between processor 208 and memory 202 and facilitate accesses to memory 202 requested by processor 208. In particular embodiments, bus 210 includes hardware, software, or both coupling components of computing system 200 to each other.

According to particular embodiments, computing system 200 performs specific operations by processor 208 executing one or more sequences of one or more instructions contained in memory 202. For example, instructions for the external data interface 120, standing determination 122, visualization configuration 124, and UI configuration 126 may be contained in memory 202 and may be executed by the processor 208. Such instructions may be read into memory 202 from another computer readable/usable medium, such as static storage 204 or dynamic storage 206. In alternative embodiments, hard-wired circuitry may be used in place of or in combination with software instructions. Thus, particular embodiments are not limited to any specific combination of hardware circuitry and/or software. In various embodiments, the term “logic” means any combination of software or hardware that is used to implement all or part of particular embodiments disclosed herein.

The term “computer readable medium” or “computer usable medium” as used herein refers to any medium that participates in providing instructions to processor 208 for execution. Such a medium may take many forms, including but not limited to, nonvolatile media and volatile media. Non-volatile media includes, for example, optical or magnetic disks, such as static storage 204 or dynamic storage 206. Volatile media includes dynamic memory, such as memory 202.

Computing system 200 may transmit and receive messages, data, and instructions, including program, e.g., application code, through communications link 218 and communications interface 216. Received program code may be executed by processor 208 as it is received, and/or stored in static storage 204 or dynamic storage 206, or other storage for later execution. A database 214 may be used to store data accessible by the computing system 200 by way of data interface 212. For example, user data 128 may be stored using a database 214. In various examples, communications link 218 may communicate with, for example, user devices to display user interfaces to the surgical coordination system 102.

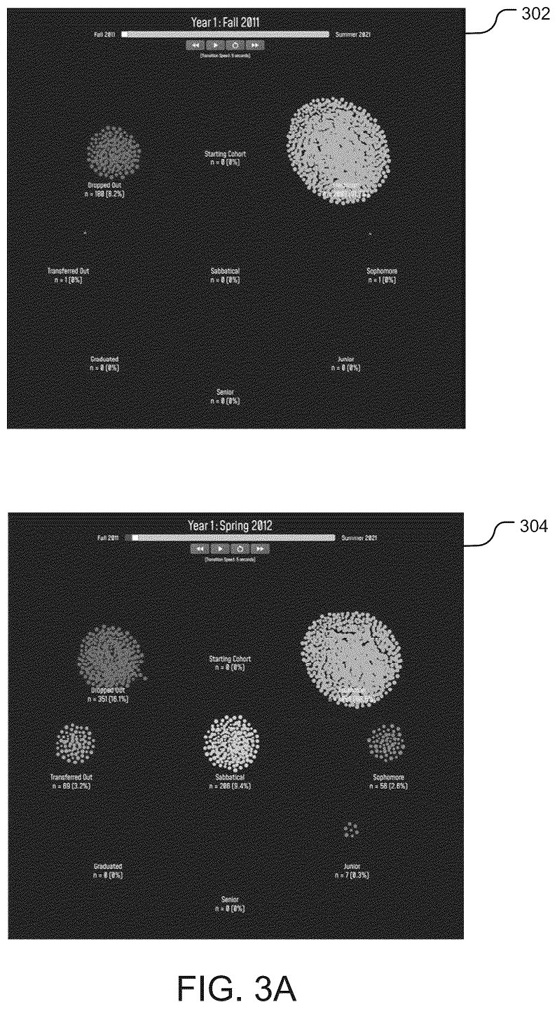

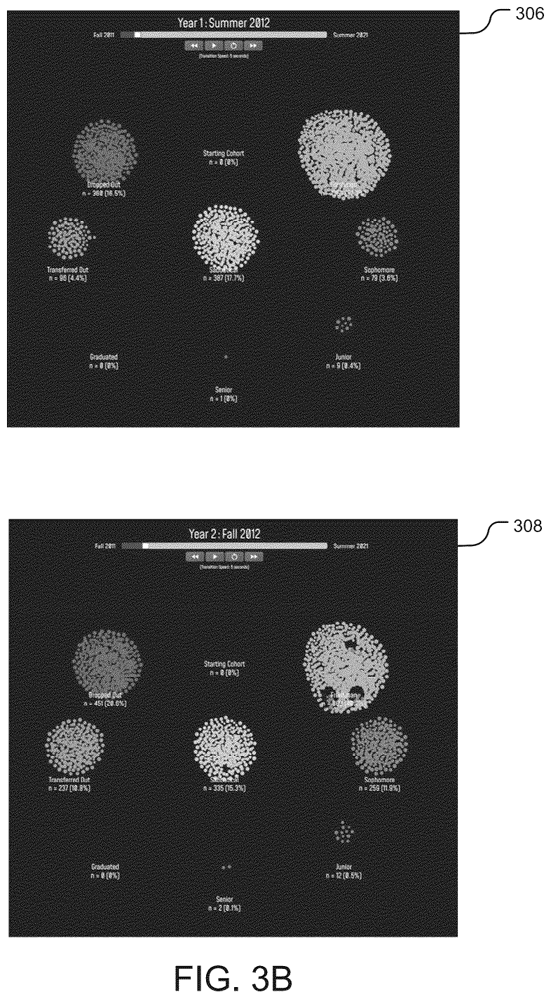

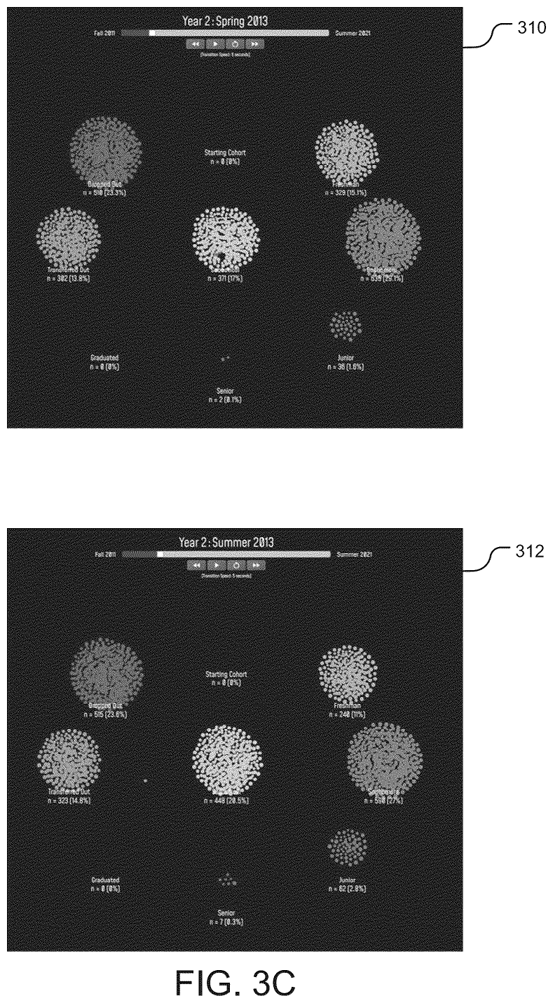

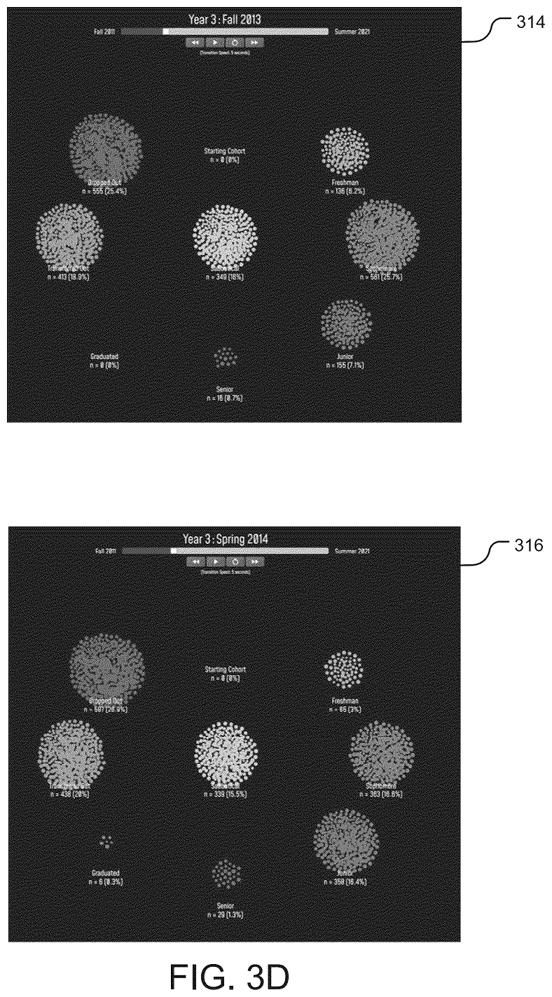

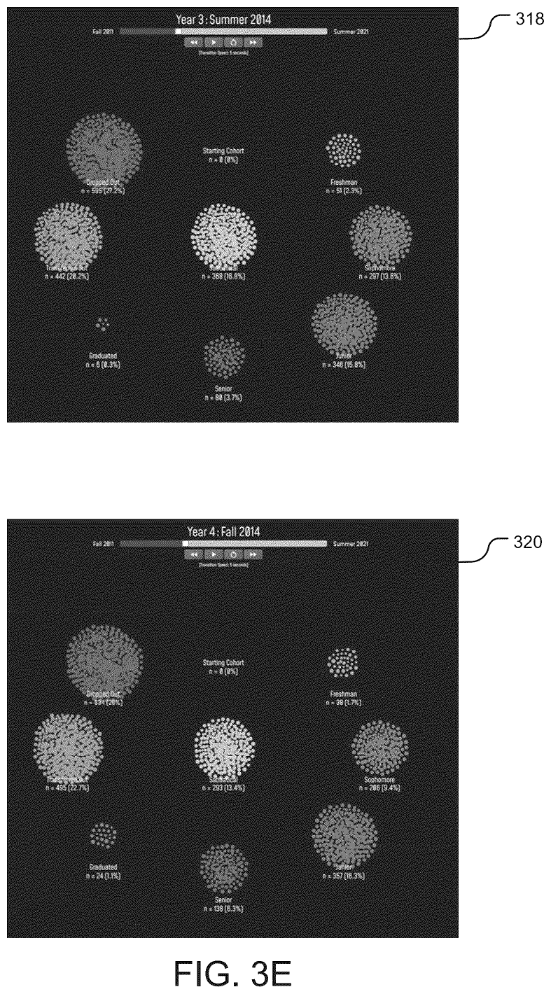

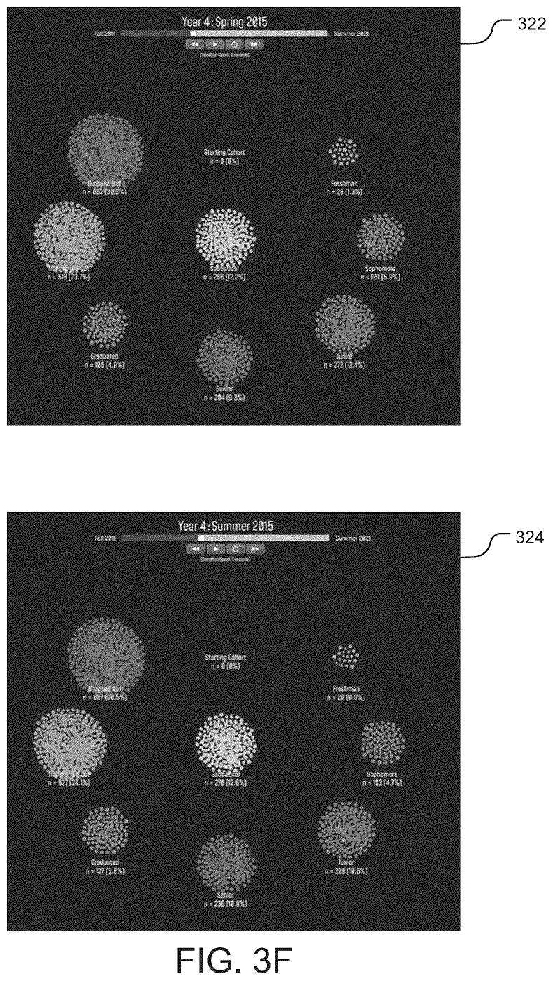

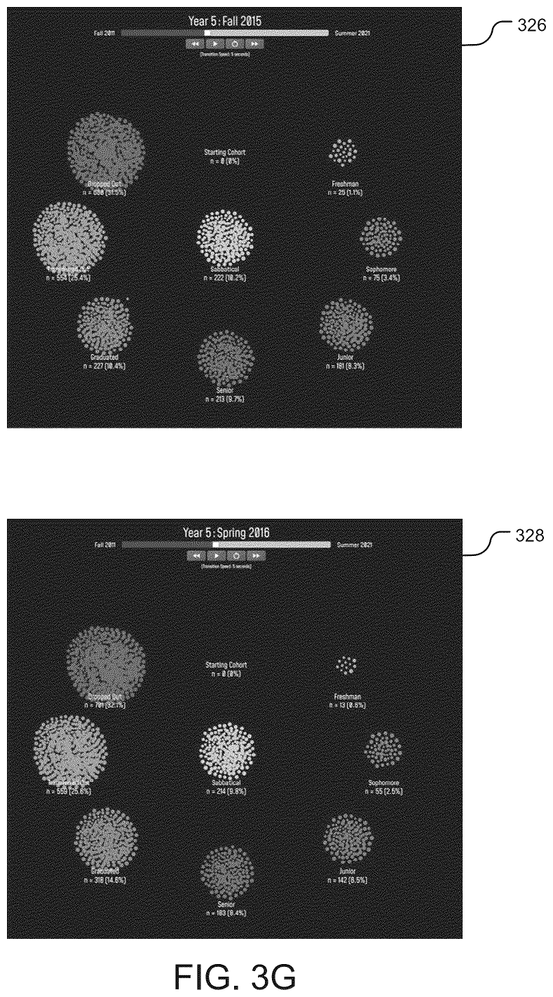

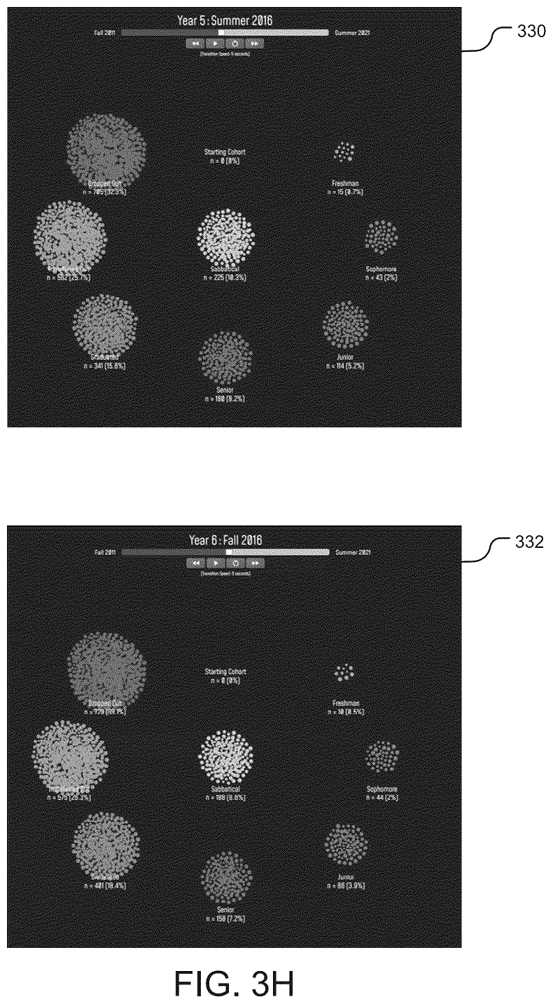

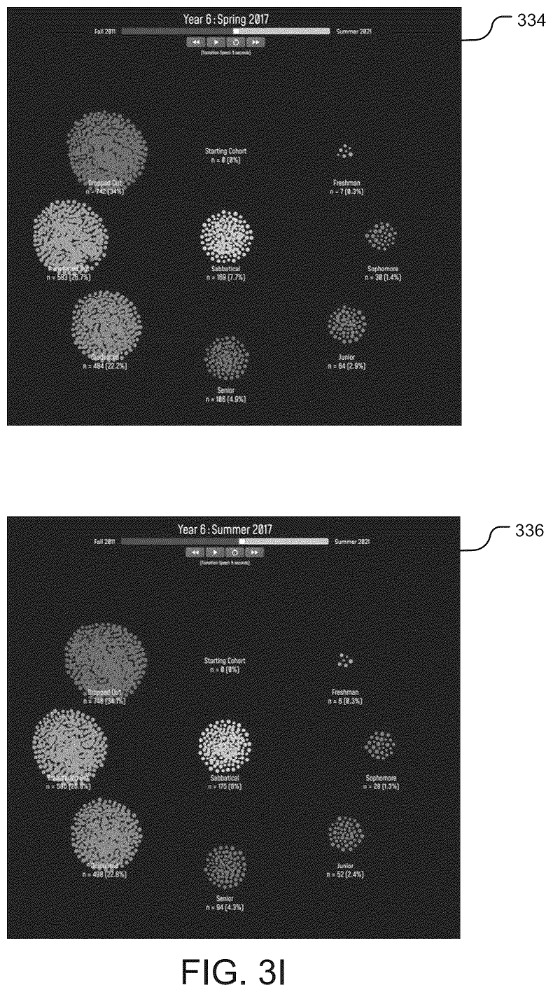

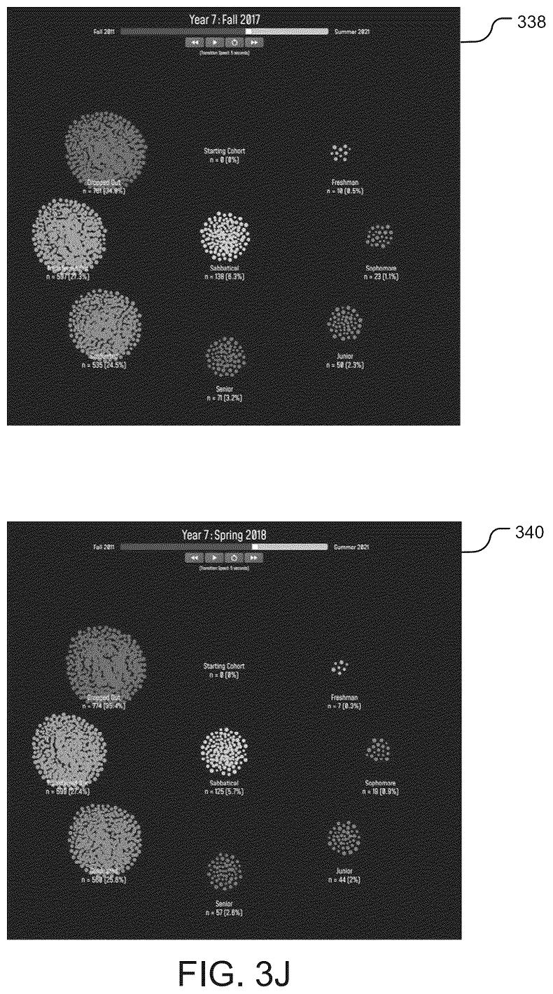

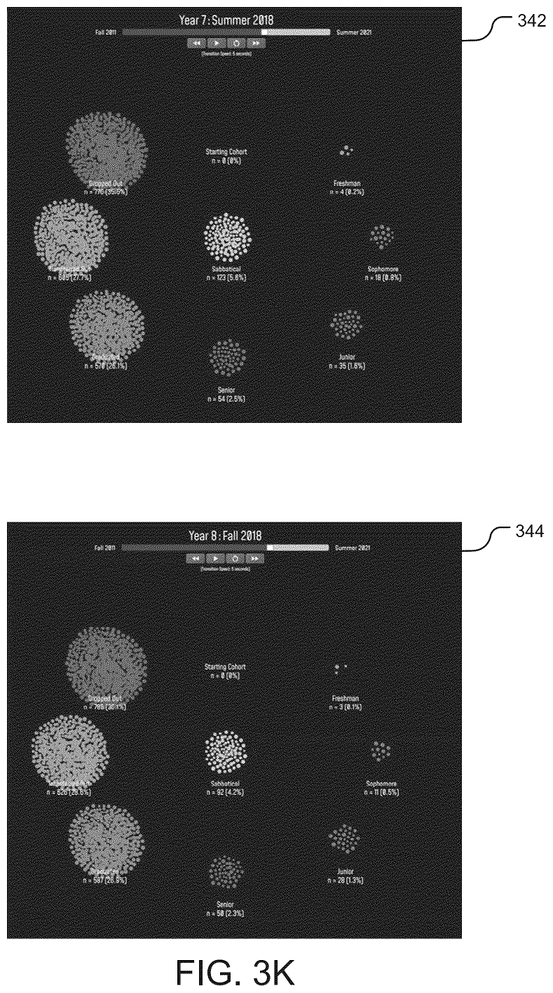

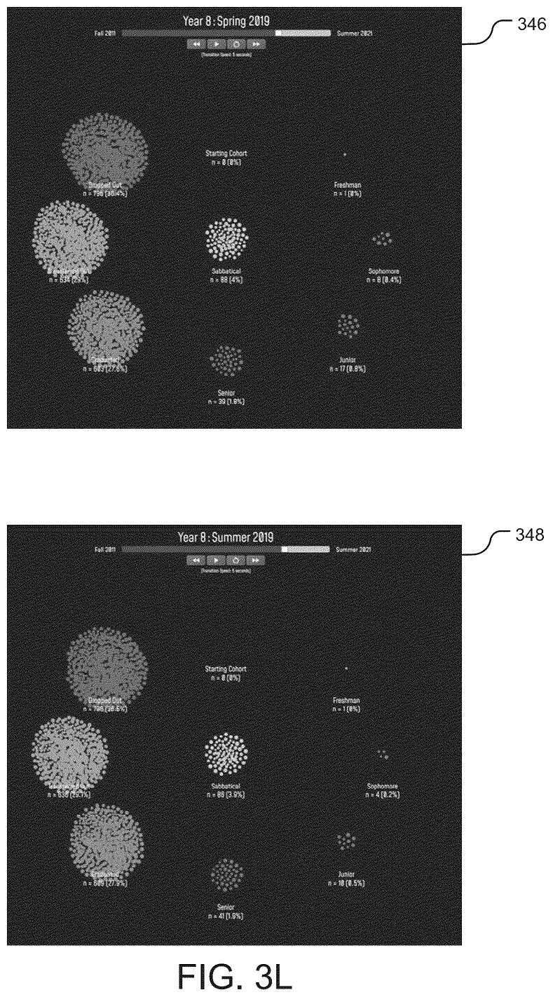

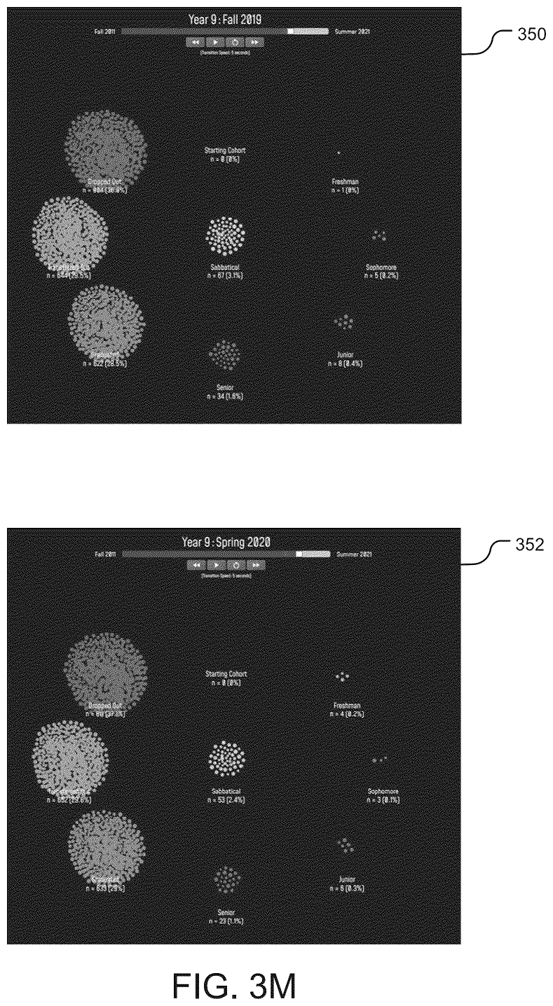

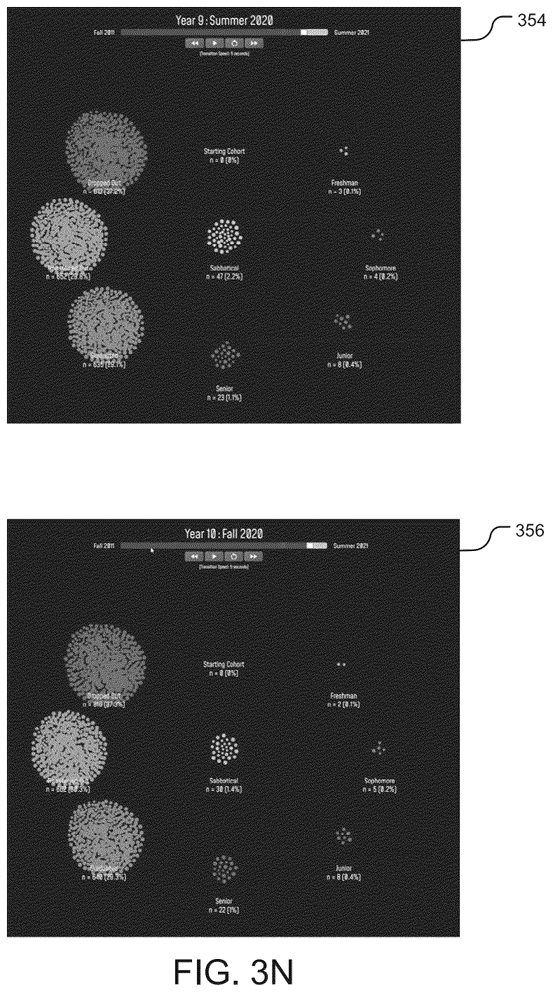

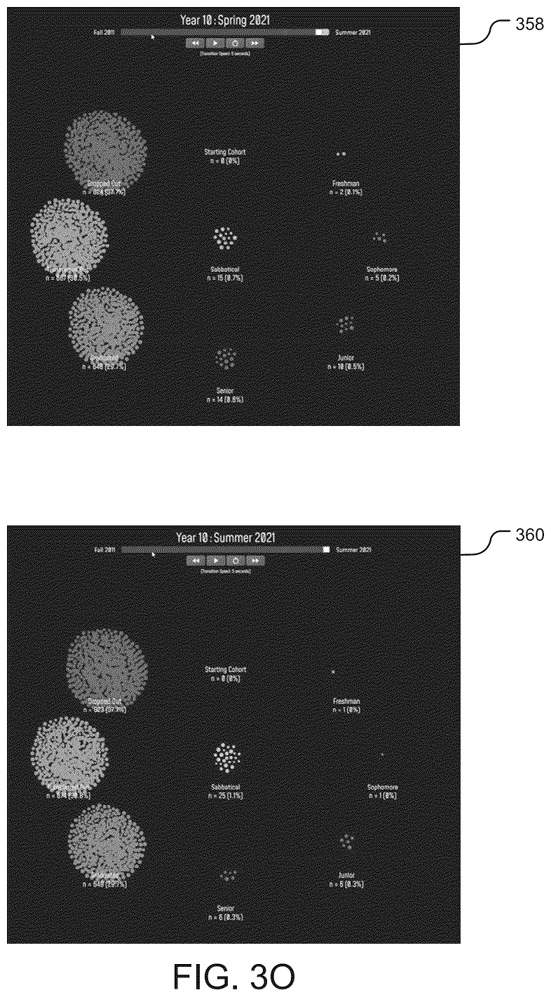

FIGS. 3A-3O illustrate example user interfaces showing visualizations of standing statuses of a cohort of students at various discrete time points over a period of time. Each of the user interfaces shown in FIGS. 3A-3O displays the standing status of a cohort of students at a discrete time point over the time period. For example, the discrete time point may be the end of an academic term (e.g., the fall semester, spring semester, and summer semester). In various examples, a visualization, as described herein, may be a dynamic visualization presented at a user interface. For example, the visualizations shown in FIGS. 3A-3O may be frames of the same larger visualization, where the larger visualization shows the movement between the individual frames. In various examples, the larger visualization may include additional frames showing transitions between the visualizations shown in FIGS. 3A-3O. Where the visualization is a dynamic visualization, the visualizations (e.g. visualization 302) may include various controls allowing a user to, for example, speed up, slow down, or pause the visualization.

The visualizations may include visual elements (e.g., colored geometric shapes, such as circles, squares, hexagons, etc.) representing students of the cohort of students. In various examples, individual students of the cohort of students may be represented by one circle. In other examples (e.g., where the cohort of students is large), a visual element may be representative of a collection (e.g., more than one) of the cohort of students. For example, a colored circle may represent five students. In these instances, the size of the visual element may be changed if, for example, different collections of students (e.g., two, four, and six) are included together in the same visualization.

With reference to FIG. 3A, the visualization 302 shows the standing statuses of students of the cohort of students at the end of a first academic term of attendance at the educational institution. As shown, the visualization may show that the majority of students retain a freshman standing, one student has transferred out of the educational institution, and one student has a sophomore standing. Further a significant number of students (180, or 8.2%) are shown as having dropped out. In various examples, the visualization 302 (and the visualizations shown in FIGS. 3B-3O) may be useful to easily visualize the status of the cohort of students. For example, the groupings of visual elements in the visualizations may be helpful to easily visualize proportions of students with various standings. For example, with reference to FIG. 3B, the groupings of visual elements for “transferred out” students and “sophomore” students are of similar size and density, showing that a similar number of students have either transferred out of the educational institution or have obtained sophomore standing. In contrast, the grouping of visual elements for “dropped out” students is both larger and denser than the transferred out or sophomore groupings, showing that a larger number of students of the cohort have dropped out in comparison to those who have transferred out of the institution. Further, the visual elements may be different colors when correlated to different standing statuses, helping to further clarify differences between numbers of students having various standing statuses.

Though the visualizations in FIGS. 3A-3O show movement of students in the cohort between class levels and enrollment statuses (e.g., on hiatus, dropped out, transferred, and/or graduated), similar visualizations may be used, in some examples, to visualize other types of status data over time. For example, visualizations may show movement of students in the cohort between majors or areas of academic concentrations over time. In such examples, major designations may replace class standing or other enrollment status indicators, and the visual elements may move between groupings representing various majors or academic concentrations. Such visualizations may be useful, for example, to identify majors having retention issues where additional academic or other supports may be useful to retain students within the major. Similarly, movement of students between various schools or colleges within a larger university may be visualized using such visualizations.

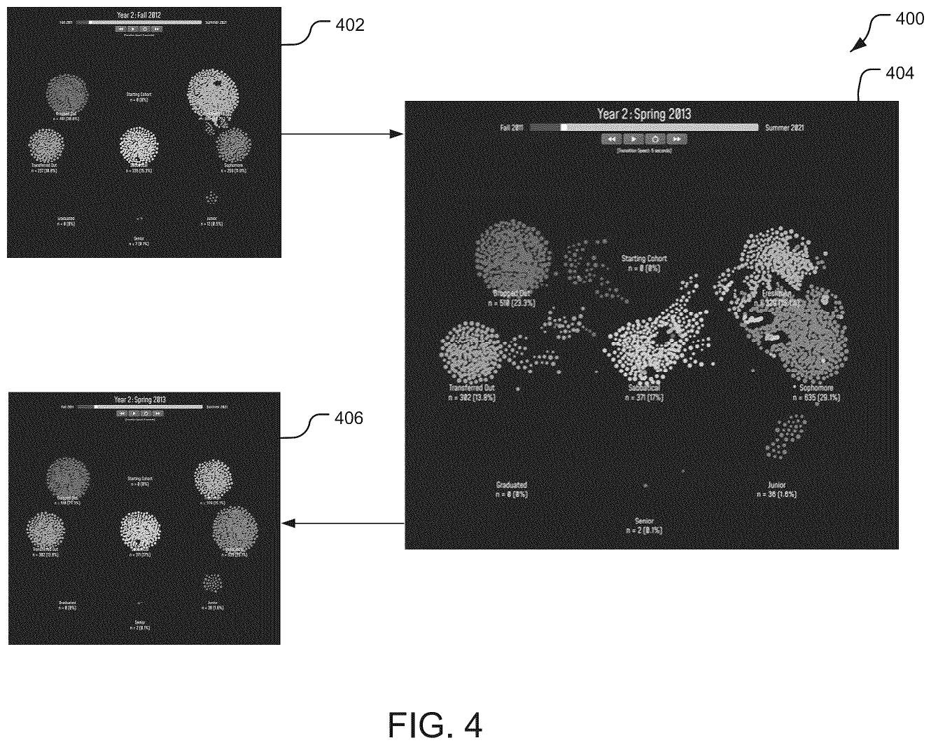

FIG. 4 illustrates example user interfaces showing visualizations of standing statuses of students over a period of time. For example, visualizations 402, 404, and 406 may be different frames of a larger visualization showing movement of a cohort of students over a time period. The visualization 404 may be shown between the visualization 402 and the visualization 406, and may be useful to show the path of the students (e.g., which standing statuses students are moving to and from). For example, the visual elements may begin at the state shown in visualization 402, reflecting the standing statuses of the students at the end of a fall semester. To transition to the standing statuses at the end of the spring semester shown in visualization 406, the visual elements may first change color to match the color of the destination standing status (e.g., the standing status shown in visualization 406). Such color changes may help to further visualize the path of students and may provide additional insights about the movement of students. For example, the visualization 404 shows that a number of students who were on hiatus at the end of the fall term (shown in visualization 402) transferred out of the institution, dropped out, returned with a freshman standing, and returned with a sophomore standing. If, for example, the hiatus grouping of visual elements showed a large number of visual elements changing to a color associated with the dropped out grouping, the visualization may help to show that a large number of students on hiatus end up dropping out of the institution and that the institution may seek to improve retention for such students by, for example, communicating during hiatus about steps to re-enroll in the institution.

Generally, in a visualization, the visual elements may move between areas of a user interface indicating a certain status. For example, different areas of the visualization 404 are labeled as “dropped out,” “transferred out,” “hiatus,” “graduated,” “freshman,” “sophomore,” “junior,” and “senior.” In the visualizations 402 and 406, the visual elements are located in a grouping, cluster, or other shape (e.g., circle, square, blob, or the like) reflecting the statuses. As shown in the visualization 404, as the movement of the visualization progresses, the visual elements move between the groupings shown in visualization 402 and visualization 406. Such visualizations allow for depiction of multiple changes in data (e.g., changes of status of different students), such that a user can visually see the changes in statuses of multiple students and patterns in the changes in statuses of the cohort of students as the groupings grow and shrink over time.

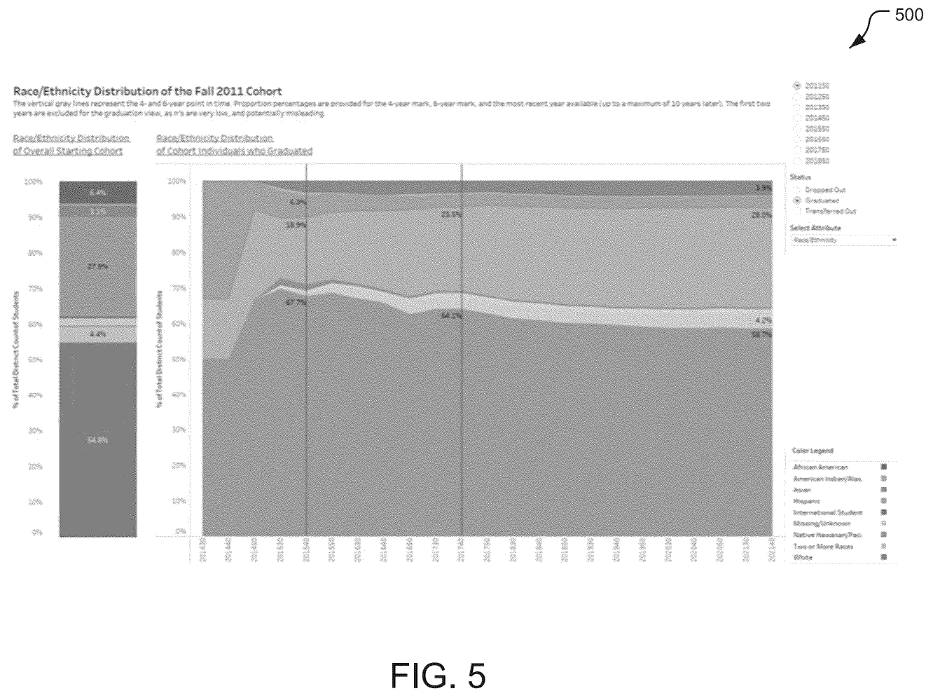

FIG. 5 illustrates an additional example user interface 500 showing a visualization of standing statuses of a cohort of students over a period of time. The visualization shown in the user interface 500 is generally a static visualization (e.g., elements of the visualization do not move over time). The visualization may show standing statuses over time of students in various demographics. For example, the visualization shown in FIG. 5 shows the proportion of students of different races who have graduated from the educational institution at the end of different academic terms, relative to the proportions of students of different races in the starting cohort. Such data may be useful to, for example, identify students having various demographic characteristics (e.g., race, sex, age, first generation status, and the like) who may be more or less likely to, for example, graduate or drop out from the institution. Such information may be useful to increase retention and provide targeted support for various groups of students. For example, where a visualization shows a large proportion of the starting demographic has a particular demographic characteristic and a smaller proportion of students graduating from the institution have the same demographic characteristic, target supports or retention efforts for students having the demographic characteristic may boost retention of those students.

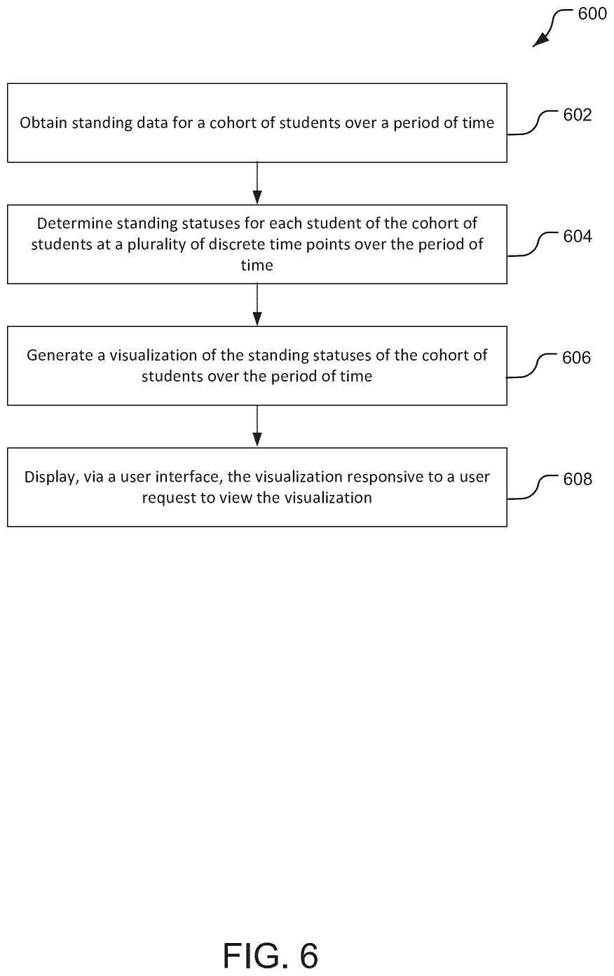

FIG. 6 is a flow diagram of operations for generating and displaying a visualization of standing statuses of a cohort of students over a period of time. At block 602, the student migration system 102 obtains status data for a cohort of students over a period of time. In various examples, the student migration system 102 may obtain such status data from one or more different datastores. For example, the student migration system 102 may obtain enrollment status and credit hours earned from a datastore maintained by a registrar of the educational institution and obtain enrollment statuses of students at other educational institutions from a datastore maintained by a third party, such as a clearinghouse or centralized datastore. In some examples, other third party databases may pull other information about students, such as career progression information, graduate school enrollment, and the like.

In various examples, to retrieve such data, external data interface 120 may format various queries to each datastore having status data, where the queries are formatted for each datastore and targeted to obtain data about students in the cohort. Formatting queries may include, for example, sending queries targeted to fields of the datastores having the relevant status data. For example, external data interface 120 may format a first query to a first datastore maintained by the registrar of the educational institution to obtain student identifiers for students first enrolling at the institution during a particular academic period (indicating inclusion of the students in the cohort) and credit hours earned at the institution by such students over the time period. The external data interface 120 may then use the student identifiers to query the second datastore to obtain enrollment information about the students of the cohort at other educational institutions during the time period.

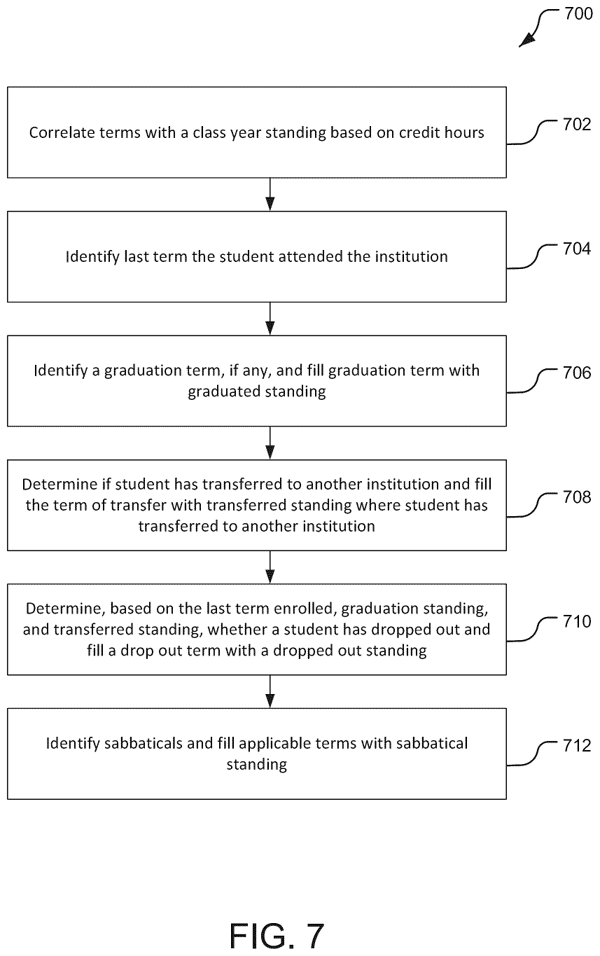

The student migration system 102 determines standing statuses for each student of the cohort of students at a plurality of discrete time points over the period of time at block 604. The standing statuses may generally be determined by standing determination 122, utilizing data about credit hours, enrollment, graduation, and the like. For example, standing determination may translate earned credit hours into class standings (e.g., freshman, sophomore, junior, or senior), utilize third-party data to determine when a student has transferred to another educational institution, determine that a student has dropped out of the educational institution based on enrollment data, and/or determine when a student is on hiatus based on data over the time period showing that a student was un-enrolled from the educational institution and re-enrolled at another point in time of the time period. One such method for determining standing statuses is described herein with respect to FIG. 7.

At block 606, the student migration system 102 generates a visualization of the standing statuses of the cohort of students over the period of time. In various examples, the visualization may be generated by generating frames of the visualization (e.g., visualizations shown in FIGS. 3A-3O) for each discrete time point over the time period. For example, visualization configuration 124 may generate a visual element representing each student in the cohort and place the visual element in a grouping of visual elements or cluster at discrete time periods reflecting the standing status of the student at the discrete time period. For example, data may be collected over a number of time periods, where the visualization may show changes over some subset of the number of time periods. For example, data may be tracked at two year increments, where the visualization shows changes every six years. Visualization configuration 124 may also configure transition frames by, for example, changing colors of the visual elements to reflect a next standing status of the student and showing movement of the visual elements from a first grouping of visual elements reflecting a current standing status to a second grouping of visual elements representing the next standing status. Visualization configuration 124 may further update text in the visualization, such as text displaying a number of students in each grouping at each discrete time point.

In some examples, visualization configuration 124 may further, responsive to a request from a user device, configure a visualization for a sub-group or portion of the cohort of students, such as a portion of the cohort of students sharing one or more demographic characteristics. For example, a user may request to view of visualization of female students enrolled in engineering majors, and visualization configuration 124 may configure such a visualization by accessing data for only students of the cohort having those two demographic characteristics. In some examples, visualization configuration may, responsive to such a request, display data for the full cohort of students, but display the data differently depending on demographic characteristics.

The student migration system 102 displays, via a user interface, the visualization responsive to a user request to view the visualization at block 608. For example, UI configuration 126 may format the visualization based on a user interface type (e.g., mobile device or desktop computer, resolution or size of the display, and the like) of the user device 106 requesting the visualization and transmit (e.g., via the network 104) the visualization to the user device 106 for viewing via the user interface 108 of the user device 106.

FIG. 7 is a flow diagram of operations 700 for determining standing statuses for a cohort of students over a period of time. In various examples, the student migration system 102 may begin the operations 700 with status data for a cohort of students, which may be retrieved by, for example, the external data interface 120 from various data sources (e.g., data sources 112 and 114, data storage 110, and/or additional data sources). The status data may be for example, a number of credit hours earned by each student in the cohort at the end of every academic term (e.g., fall semester, spring semester, and summer term) included in the time period for the visualization. In some examples, status data may further include enrollment status of each student in the cohort (e.g., whether the student is enrolled in the educational institution, another educational institution, or not enrolled in any courses), graduation status for each student in the cohort (e.g., a term after which a degree was conferred on the student from the educational institution, a binary status of graduated or not graduated, and the like), and/or data about student registration at other educational institutions (e.g., data received from the National Student Clearinghouse®).

After gathering the status data, the student migration system 102 may populate a table or other data structure with the status data. For example, each row of a table may correlate to a student of the cohort of students (e.g., identified by student identifier), with each column correlating to a discrete time, such as an academic term, in the period of time covered by the visualization. The student migration system 102 (e.g., standing determination) may fill cells of the table with a number of credit hours earned by students in the cohort, where the student was enrolled at the educational institution during the relevant term. Accordingly, the table may include blank cells where at student was not enrolled at the educational institution for the relevant term, and standing determination 122 may, through the operations 700, determine the standing of students during those terms. For example, blank terms may be associated with a class standing (e.g., during a non-mandatory term such as a summer term), a transferred out status (e.g., where the student has transferred to another educational institution), a hiatus status (e.g., where a student has taken time off from a degree program to later return), a graduated status (e.g., where a student has completed the degree program), and/or a drop-out status (e.g., where the student has un-enrolled from a degree program and does not return to the educational institution or another educational institution). While the operations 700 are described with respect to a table, other data structures may be used to store status data and standing statuses in various examples.

At block 702, the student migration system 102 (e.g., standing determination 122) correlates terms with a class year standing based on credit hours. Standing determination 122 may, for example, replace cells in the table populated with earned credit hours with a corresponding class standing. For example, a student having earned between 0-30 credit hours may be classified as a freshman, a student having earned between 30-60 credit hours may be classified as a sophomore, a student having earned between 60-90 credit hours may be classified as a junior, and a student having earned over 90 credit hours may be classified as a senior. Such ranges may vary based on definitions used by the educational institution.

The student migration system 102 identifies the last term the student attended the institution at block 704. The last term may be, for example, the last term that the student has recorded enrollment at the educational institution. In some examples, standing determination 122 may remove any credit hours appearing after the identified last term. This action may correctly format terms for students who, for example, transfer additional credits into the educational institution (e.g., credits earned at other institutions) without actually re-enrolling in the educational institution.

At block 706, the student migration system 102 identifies a graduation term, if any, and fills the graduation term with a graduated standing. Standing determination 122 may receive, in some examples, graduation status with the status data. For example, graduation status data may be received as a listing of student identifiers and graduation terms. In these examples, standing determination 122 may locate such student identifiers in the table and replace the last term attended with a graduated status. The graduated status may then be filled forward to all remaining columns in the row for the student. Accordingly, once a student has earned a degree from the educational institution, the student retains a graduated status for the remainder of the time period for purposes of the visualization.

The student migration system 102 determines if the student has transferred to another institutions and fills the term of transfer with transferred standing where the student has transferred to another institution at block 708. Standing determination 122 may utilize third-party enrollment data (e.g., data about enrollment of the student at another educational institution) to determine transfer standing. For example, data received from the National Student Clearinghouse® may include a row for each student, including the institution attended by the student and a standing of the student associated with each term. For students not having a graduated status, standing determination 122 may access such data to determine if the student has data indicating that, during the time period used for the visualization and after the last term the student attended the educational institution, the student was enrolled at another educational institution as a degree seeking student. Where such data does exist, the remaining terms in the time period after the last term attended may be filled with a transferred out standing status.

At block 710, the student migration system 102 determines, based on the last term enrolled, graduation standing, and transferred standing, whether a student has dropped out and fills a drop out term with a dropped out standing. For example, a student may be considered to have dropped out when the student has not graduated, is not enrolled in the educational institution, has not enrolled elsewhere, and does not return to the educational institution within the time period. Accordingly, students having a last term attended status that has not been replaced with a graduated or transferred standing may be identified as having dropped out of the educational institution and the remaining terms in the time period after the last term may be replaced with a dropped out standing.

The student migration system 102 identifies hiatuses and fills applicable terms with a hiatus standing at block 712. Standing determination 122 may locate cells not already filled in (e.g., cells before a last term attended) and fill in such cells with a hiatus standing. For example, students may be identified as on a hiatus where the student is not enrolled in the educational institution for one or more terms (e.g., no class standing is provided) and eventually returns to the educational institution or another educational institution. In some examples, before filling in hiatus status, standing determination 122 may forward fill values from regular terms (e.g., fall semester and spring semester) to non-mandatory or optional terms, such as summer sessions. Accordingly, students who follow a regular pattern of enrolling in the fall and spring semesters, but not during optional summer sessions, are not incorrectly identified as on a hiatus.

Using the operations 700, the student migration system 102 may generate a filled table or other data structure including complete standing statuses for a cohort of students over a period of time. Such a table may be utilized by the student migration system 102 (e.g., by visualization configuration 124) to generate visualizations showing the path of students in the cohort through the various standing statuses. Such visualizations may help with institutional planning to meet student retention goals by showing more clearly where students deviate from the expected path towards a degree from the educational institution. For example, visualizations generated using the student migration system 102 may show that a large number of students drop out after the first year of the time period, suggesting that the educational institution may increase student retention by developing additional supports for students in the first year of attendance at the educational institution.

In accordance with the above description, the student migration system 102 disclosed herein may generate and transmit visualizations showing paths of a cohort of students through an educational institution. Such visualizations may utilize data from various data sources and may be useful for obtaining information about such paths of students that may not be readily apparent through conventional statistics or using data only from the institution. For example, such visualizations may be dynamic, showing how students move between standing statuses which may show, for example, the standing statuses of students the semester before such students drop out. Such information may be difficult to obtain from statistical analysis or from, for example, charts showing numbers of students having various standing statuses at the end of various semesters. Accordingly, the student migration system disclosed herein may be useful in better designing and implementing retention efforts based on actual paths of students through the educational institution.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A method for generating a visualization of movement of a cohort of students through an educational institution, the method comprising:
obtaining status data for the cohort of students over a time period;
determining standing statuses for students of the cohort of students, the standing statuses being determined at a plurality of discrete time points over the time period;
generating the visualization of the standing statuses over the time period, wherein the visualization shows changes between the standing statuses over the time period; and
displaying, via a user interface at a user device, the visualization responsive to a user request received from the user device to view the visualization.

2. The method of claim 1, wherein the status data includes a number of credit hours earned at the educational institution by students of the cohort of students at each of the plurality of discrete time points over the time period.

3. The method of claim 2, wherein the status data includes enrollment status of at least one student of the cohort of students at a second educational institution during the time period, wherein the second educational institution is different than the educational institution.

4. The method of claim 3, wherein obtaining the status data for the cohort of students over the time period comprises obtaining the number of credit hours earned at the educational institution by students of the cohort of students from a first datastore and obtaining the enrollment status of the at least one student of the cohort of students at the second educational institution from a second datastore.

5. The method of claim 2, wherein determining standing statuses for the cohort of students over the time period comprises using the number of credit hours earned at the educational institution by each student of the cohort of students at each of the plurality of discrete time points over the time period.

6. The method of claim 1, further comprising:
receiving, via the user interface at the user device, a second user request to generate a second visualization for a subset of the cohort of students over the time period, wherein the subset of students includes students having a demographic characteristic;
obtaining demographic data for the cohort of students;
identifying the subset of the cohort of students based on the demographic data; and
generating the second visualization of standing statuses of the subset of the cohort of student over the time period.

7. The method of claim 1, wherein the visualization shows at least the standing statuses of the cohort of students at each of the plurality of discrete time points over the time period.

8. The method of claim 7, wherein the visualization includes a plurality of visual elements representing the cohort of students, wherein the visualization shows the visual elements in motion.

9. A computing system comprising:
one or more processors; and
memory containing instructions which, when executed by the one or more processors, cause the computing system to perform a method comprising:
receiving, via a user interface at a user device in communication with the computing system, a request to generate a visualization of standing statuses of a cohort of students over a time period,
obtaining, from at least two databases, status data for the cohort of students over the time period,
determining standing statuses for students of the cohort of students, the standing statuses being determined at a plurality of discrete time points over the time period,
generating the visualization of the standing statuses of the cohort of students over the time period, wherein the visualization shows changes between the standing statuses over the time period, and
displaying, via the user interface, the visualization.

10. The computing system of claim 9, wherein obtaining, from at least two databases, status data for the cohort of students comprises:
obtaining a number of credit hours earned at the educational institution by each student of the cohort of students from a first datastore, the first datastore associated with the educational institution; and
obtaining an enrollment status of at least one student of the cohort of students at a second educational institution from a second datastore, the second datastore associated with an entity separate from the educational institution.

11. The computing system of claim 9, wherein the status data includes a number of credit hours earned at the educational institution by students of the cohort of students at each of the plurality of discrete time points over the time period.

12. The computing system of claim 11, wherein determining standing statuses for the cohort of students over the time period comprises using the number of credit hours earned at the educational institution by students of the cohort of students at each of the plurality of discrete time points over the time period.

13. The computing system of claim 9, wherein the visualization shows at least the standing statuses of the cohort of students at each of the plurality of discrete time points over the time period.

14. The computing system of claim 13, wherein the visualization includes a plurality of visual elements representing the cohort of students, wherein the visualization shows the visual elements in motion.

15. The computing system of claim 9, wherein the method further comprises:
receiving, via the user interface, a request to update a display characteristic of the visualization;
generating an updated visualization based on the request; and
displaying, via the user interface, the updated visualization.

16. A method for generating a visualization of movement of a cohort of students through an educational institution, the method comprising:
obtaining status data for the cohort of students over a time period, the status data including a number of credit hours earned by students of the cohort at the educational institution at a plurality of discrete time points over the time period;
determining, based on the number of credit hours earned by each student of the cohort of students, standing statuses for students of the cohort of students at each of the plurality of discrete time points over the time period;
generating the visualization of movement of the cohort of students over the time period, wherein the visualization shows at least the standing statuses of the cohort of students at each of the plurality of discrete time points; and
displaying, via a user interface, the visualization responsive to a user request received from the user device to view the visualization.

17. The method of claim 16, wherein the status data further includes an enrollment status of at least one student of the cohort of students at a second educational institution, wherein obtaining status data for the cohort of students over the time period comprises:
obtaining the number of credit hours earned by students of the cohort of students at the educational institution at a plurality of discrete time points from a first datastore; and
obtaining the enrollment status of the at least one student of the cohort of students at a second educational institution from a second datastore.

18. The method of claim 16, wherein the visualization includes a plurality of visual elements representing the cohort of students, wherein the visualization shows the visual elements in motion.

19. The method of claim 18, wherein the plurality of visual elements are colored and clustered together based on the standing statuses of the cohort of students.

20. The method of claim 16, further comprising:
receiving, via the user interface at the user device, a second user request to generate a second visualization for a subset of the cohort of students over the time period, wherein the subset of students includes students having a demographic characteristic;
obtaining demographic data for the cohort of students;
identifying the subset of the cohort of students based on the demographic data; and
generating the second visualization of standing statuses of the subset of the cohort of students over the time period.
